(19) United States
(12) Patent Application Publication
(10) Pub. No.: US 2001/0048040 A1
(43) Pub. Date: Dec. 6, 2001

(54) Back-pressure responsive, self-reversing, control valve

(76) Inventor: Paul C. Sheldon, Mequon, WI (US)

Correspondence Address: Garron M. Hobson, THORPE, NORTH & WESTERN, LLP, P.O. Box 1219, Sandy, UT, 84091-1219, US

(21) Appl. No.: 09/775,145

(22) Filed: Feb. 1, 2001

Related U.S. Application Data
(60) Provisional application No. 60/180,342, filed on Feb. 4, 2000.

(51) Int. Cl. B02C 23/36

(52) U.S. Cl. 241/46.013

(57) ABSTRACT

A back-pressure responsive, self-reversing, control valve is coupled to a water powered waste disposal unit. The control valve includes first and second bi-directional valves which operate cooperatively to direct fluid from an inlet to a respective first and second opening, and facilitate drainage of fluid from one of the respective first and second openings to an outlet. A back-pressure responsive actuator is operatively coupled to the first and second valves to operate the first and second valves cooperatively in response to back-pressure at the first and second openings. A hysteretic actuator can be used to operate the first and second valves rapidly between the first and second positions upon a predetermined amount of back-pressure at either the first or second openings.

This application claims the benefit of U.S. Provisional application Ser. No. 60/180,342, filed Feb. 4, 2000.

### BACKGROUND OF THE INVENTION

1. Field of the Invention.

The present invention relates generally to a back-pressure responsive, self-reversing, control valve, particularly well suited for use with a water powered waste disposal unit.

2. Related Art.

Waste disposal units disposed under sinks have become commonplace. The waste disposal unit cuts or shreds waste, such as table scraps, so that the waste may pass through pipes of a house plumbing system without clogging the pipes. The disposal units provide the convenience of simply washing waste directly into the sink without having to first wipe the waste into a trash receptacle or having to later clear the waste from a drain in the sink. Disposal units are typically mounted under the sink between the drain in the bottom of the sink and the pipes of the plumbing system and typically have cutters disposed in the units and coupled to electric motors to cut the waste as it passes through the units.

Despite the conveniences provided by these waste disposal units, there are several disadvantages, one of which is the need for electrical wiring to operate the motor. Because of this, the devices are difficult to install and pose a danger of coupling an electric source to the water and plumbing system. Another disadvantage is the low starting torque of the electric motors. 5 Waste initially disposed in the unit may stall the motor. Thus, the motor may burn out or pose a danger of injury as a user reaches into the unit to remove the clogged waste.

U.S. Pat. Nos. 3,700,178, issued Oct. 24, 1972, to Verley, and 4,082,229, issued Apr. 4, 1978, to Boosman, disclose water powered waste disposal units. The units have a housing defining an annular chamber around the unit. A reciprocating drive piston is slidingly disposed in the chamber and is coupled to a pivoting cutter in the housing. A valve alternately directs pressurized water into the annular chamber on opposite sides of the drive piston to drive the piston, and thus the cutter, in a reciprocal rotating motion.

U.S. Pat. No. 4,399,947, issued Aug. 23, 1983, to Spelber et al. discloses a valve for directing the water for a water powered disposal unit. The valve has a reciprocating control piston slidingly disposed in a valve housing. The control piston has a channel formed therein for alternately directing water into the annular chamber on either side of the drive piston as the control piston reciprocates in the valve housing. The valve also has a reciprocating pilot piston slidingly disposed in the housing. The pressure in the annular chamber forces the pilot piston to reciprocate. The pilot piston has a chamber formed therein for alternately directing water to opposite sides of the control piston as the pilot piston reciprocates, thus forcing the control piston to reciprocate.

A detent is disposed in the housing and engages the pilot piston. A spring biases the detent against the pilot piston so that the detent and spring apply an amount of resistance to the pilot piston. The water pressure developed in the annular housing must overcome the amount of resistance applied by the detent to the pilot piston in order to cause the pilot piston to reciprocate.

Despite advantages presented by the above-described water powered waste disposal units, there are also disadvantages. One is the water pressure operating requirement of the water powered units. The units require a certain amount of water pressure to initiate operation of the units. Different water sources, however, provide various different water pressures. Thus, the units may work in some areas, but not in others, depending upon the water pressure available. In addition, water pressure tends to fluctuate during the day. The pressure is lower during times of greater usage, and so the units may work at some times during the day, but not at others.

Furthermore, the water pressure operating requirements of the units result in inefficiencies. A unit designed to be used with various different water pressures, and thus lower water pressures, must have components capable of operating at lower pressures. But those same components may not be suitable to fully and efficiently utilize higher water pressures.

Another disadvantage with the water powered units is the difficulty in obtaining consistent and accurate performance characteristics from components. For example, the components applying resistance to movement of the pilot piston may apply an inconsistent amount of resistance, possibly resulting in non-functionality.

Another disadvantage of the water powered units is the tight or close tolerances required. Variations in the unit dimensions and springs result in pressure variations which may or may not be sufficient to properly operate the unit. The high tolerances make the units very expensive and are difficult to obtain in less expensive, injection molded parts without further machining or process steps. These drawbacks have prevented the substantial advantages of the water powered waste disposal units from being enjoyed.

U.S. Pat. No. 5,971,304, issued Oct. 26, 1999, to Sullivan, discloses a water powered waste disposal unit with adjustable torque and water pressure operating requirements. Specifically, Sullivan discloses an adjustable valve for adjusting the water pressure operating requirements of the valve and torque of the apparatus. The valve has a valve housing coupled to a source of pressurized water and to the first and second water openings of the housing to alternately direct the pressurized water to the first and second water openings, and thus drive the drive piston in a reciprocal manner. A reciprocating control piston is slidably disposed in the valve housing between first and second control positions. The control piston has opposite sides and an annular notch or a control channel formed therein for directing the pressurized water. As the control piston reciprocates between the first and second control positions, it alternately directs the pressurized water to the first and second openings, thus driving the drive piston in a reciprocal rotational motion.

A reciprocating pilot piston is slidably disposed in the valve housing between first and second pilot positions. The pilot piston has opposite sides and an annular notch or a pilot channel formed therein for directing the pressurized water. As the pilot piston reciprocates between the first and second pilot positions, it alternately directs the pressurized water to the opposite sides of the control piston, thus driving the control piston in a reciprocal motion.

The valve housing has first and second passageways formed therein and extending between the opposite sides of the pilot piston and the first and second openings. Water pressure is communicated from the annular chamber to the pilot piston to reciprocate the pilot piston. A detent engages the pilot piston and applies an amount of resistance to movement of the pilot piston between the first and second pilot positions. A spring may bias the detent against the pilot piston. Thus, the water pressure in the annular chamber, and thus at the opposite sides of the pilot piston, must reach a certain threshold pressure in order to overcome the amount of resistance applied by the detent and move the pilot piston.

The amount of resistance applied by the detent may be adjusted by an adjustment member. The adjustment member may movably engage the spring, thus adjusting the amount of resistance applied by the detent. Therefore, the maximum torque of the disposal apparatus, or at least one cutter, may be adjusted. In addition, the operating pressure requirement may be accomodated.

Despite advantages presented by the above-described improved control valves, there are also disadvantages. One is the susceptibility to grit and contaminants contained in the water. Another is a reduction in flow rate and water pressure. Yet another is the efficiency in which water is used. Yet another is the need for the valve components to be precision manufactured. Yet another is the requirement of numerous seals and wear surface.

### SUMMARY OF THE INVENTION

It has been recognized that it would be advantageous to develop a control valve, particularly for use with a water powered waste disposal unit, for controlling a reciprocating piston by alternating the flow of fluid to opposite sides of the piston. In addition, it has been recognized that it would be advantageous to develop a control valve which is simple, reliable, and efficient. In addition, it has been recognized that it would be advantageous to develop a control valve with fewer seals and wear surface. In addition, it has been recognized that it would be advantageous to develop a control valve which is resistant to grit and contaminants. In addition, it has been recognized that it would be advantageous to develop a control valve with higher flow rates, and thus higher speeds. In addition, it has been recognized that it would be advantageous to develop a control valve with increased dynamic pressure, and thus increased force during movement.

The invention provides a back-pressure responsive, self-reversing, control valve which is particularly well suited for water powered waste disposal units. The control valve includes first and second bi-directional valves which operate cooperatively to: (i) direct fluid from an inlet to respective first and second openings, and (ii) facilitate drainage of fluid from one of the respective first and second openings to an outlet. One of the first and second valves facilitates drainage of fluid from one of the respective first and second openings to an outlet, while the other one of the first and second valves directs fluid to the other one of the respective first and second openings. A back-pressure responsive actuator is operatively coupled to the first and second valves to operate the first and second valves cooperatively in response to back-pressure at the first and second openings.

In accordance with a more detailed aspect of the present invention, the control valve is coupled to a water powered waste disposal unit driven by pressurized water. The disposal unit has a reciprocating drive piston slidably disposed in a drive chamber. The drive piston is coupled to cutters in the unit for cutting waste. The drive chamber having first and second openings formed therein on opposite sides of the drive piston which are coupled to the first and second openings of the first and second valves.

In accordance with another more detailed aspect of the present invention, the control valve further includes a fluid passageway extending between the inlet and the outlet. The first and second valves are disposed in the fluid passageway between the inlet and the outlet. The valves are operable to direct the fluid (i) from the inlet to the respective first and second openings, and (ii) from the respective first and second openings to the outlet.

In accordance with another more detailed aspect of the present invention, the first and second valves can include first and second ball valves. Each ball valve has a ball with an angular passage pivotable between a first power orientation and a second drain orientation. In the first power orientation, the angular passage directs fluid from the inlet to the respective first and second openings. In the second drain orientation, the angular passage directs fluid from the respective first and second opening to the outlet.

In accordance with another more detailed aspect of the present invention, the first and second valves are operatively interconnected to simultaneously alternate operation. The first and second valves can include first and second valve levers coupled to the respective first and second valves to operate the valves and direct fluid flow. An armature is coupled to and between the first and second valve levers to operatively interconnect the first and second valves.

In accordance with another more detailed aspect of the present invention, the control valve can include a hysteretic actuator to operate the first and second valves rapidly between the first and second positions. The hysteretic actuator is operatively coupled to the first and second valves, and is responsive to back pressure at the first and second openings to rapidly operate the first and second valves upon a predetermined amount of back-pressure at either the first or second opening.

In accordance with another more detailed aspect of the present invention, the hysteretic actuator includes a bi-stable mechanism having two stable positions each corresponding to one the first power position or second drain position of the valves.

In accordance with another more detailed aspect of the present invention, the hysteretic actuator includes a back-pressure responsive actuator and a resilient member or spring. The back-pressure responsive actuator is operatively coupled to the first and second openings and exerts a force in response to back-pressure at the first and second openings. The resilient member or spring has a first end pivotally coupled to the valves at a first pivot point, and a second end pivotally coupled to the pressure responsive actuator at a second pivot point. The distance between the first and second pivot points is fixed. The resilient member moves between first and second arcuate configurations corresponding with the first and second power positions. The resilient member exhibits or passes through an s-shaped configuration between the first and second arcuate configurations in which the resilient member stores energy used to switch the valves between the first and second positions.

In accordance with another more detailed aspect of the present invention, the control valve further includes a detent mechanism to exert a resistance force to movement of the actuator. The detent mechanism operatively engages the pressure response actuator.

In accordance with another more detailed aspect of the present invention, the control valve further includes an adjustment member which is coupled to the detent mechanism to adjust the amount of resistance applied by the detent.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

FIG. 1 is a side view of a water powered waste disposal apparatus with a control valve in accordance with the present invention shown coupled to a sink and source of pressurized water;

FIG. 2 is a top view of the water powered waste disposal apparatus with the control valve of FIG. 1;

FIG. 3 is a side, cross-sectional view of the water powered waste disposal apparatus of FIG. 2, taken along section 3-3;

FIG. 4 is an exploded view of the water powered waste disposal apparatus with the control valve of FIG. 1;

FIG. 5 is a partial broken-away perspective view of the control valve in accordance with the present invention;

FIG. 6 is an exploded view of the control valve of FIG. 5;

FIG. 7 is a partial perspective view of the control valve of FIG. 5;

FIG. 8 is a partial perspective view of the control valve of FIG. 5;

FIG. 9 is a cross sectional view of a detent mechanism and an adjustment mechanism in accordance with the present invention; and

FIG. 10 is a partial front view of a detent track of the detent mechanism of FIG. 9.

### DETAILED DESCRIPTION

For the purposes of promoting an understanding of the principles of the invention, reference will now be made to the exemplary embodiments illustrated in the drawings, and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

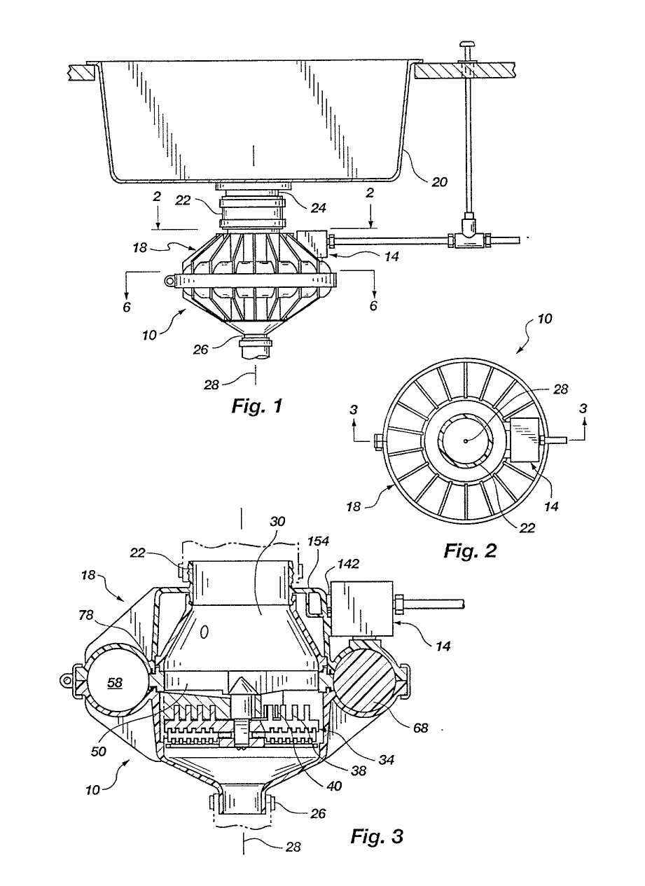

Referring to FIGS. 1-4, a water powered waste disposal apparatus, indicated generally at 10, for cutting waste is shown with a back-pressure responsive, self-reversing, control valve, indicated generally at 14, of the present invention. Such water powered waste disposal units are one example of a field which may benefit from use of a control valve as hereinafter described. Water powered waste disposal units, and various aspects thereof, are disclosed in U.S. Pat. Nos. 3,700,178; 4,082,229; 4,399,947; 4,405,159; 4,553,560; 4,573,642; 5,971,304; 5,931,395; 6,012,662; 6,109,551, which are herein incorporated by reference.

The disposal apparatus 10 has an apparatus housing 18 adapted for being disposed under a sink 20, as shown in FIG. 1. The housing 18 has a waste inlet 22 disposed generally at the top of the housing 18 for allowing the waste into the housing 18. The housing 18 and/or inlet 22 may be configured for being coupled to a drain 24 of a sink 20, as shown in FIG. 1. The housing 18 also has an outlet 26 disposed generally at the bottom of the housing 18 for allowing the waste out of the housing 18. The housing 18 may have a longitudinal axis 28 extending vertically between the inlet 22 and outlet 26.

Referring to FIG. 3, the housing 18 also defines a waste passage 30 formed in the housing 18 and extending between the waste inlet 22 and the outlet 26. The passage 30 may be concentric with the longitudinal axis 28 of the housing 18 and have a circular cross section.

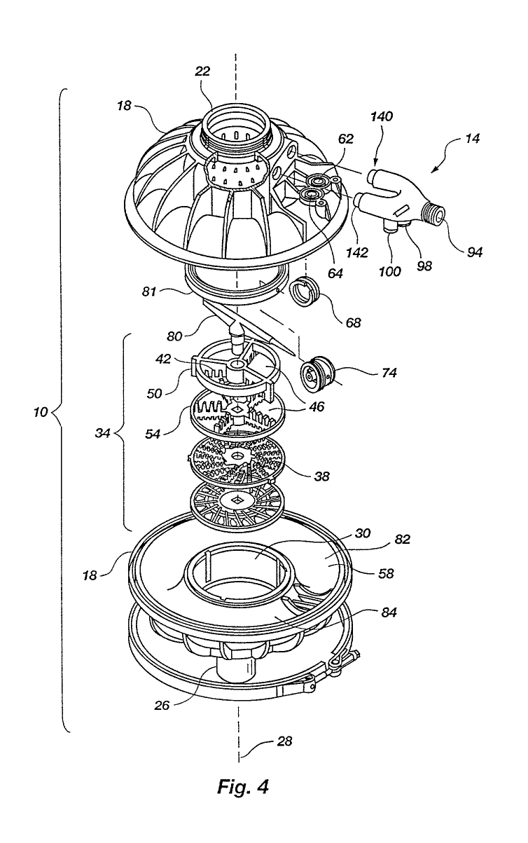

Referring to FIGS. 3 and 4, a plurality of cutters 34 are disposed in the passage 30 of the housing 18. The cutters 34 may be arranged in layers, or may be stacked, and preferably are the same shape as the passage 30, such as circular. The cutters 34 may be plates and have blades 38 or portions which protrude and interlock with grooves 42 formed in adjacent cutters 34. The cutters 34 have a plurality of openings 46 formed therein for permitting the waste to pass through the cutters 34, as shown in FIG. 4.

Some of the cutters 50 may be secured, or fixedly disposed, to the housing 18 or passage 30. At least one cutter is a pivoting cutter 54 pivotally disposed in the passage 30. The pivoting cutter 54 pivots about the longitudinal axis 28 of the housing 18. The blades 38 and grooves 42 of the adjacent cutters 50 and 54 inter-couple. As the waste passes through the openings 46 in the cutters 34, the waste is cut between the pivoting cutters 54 and the fixed cutters 50.

Referring to FIGS. 3 and 4, the housing 18 also defines an annular drive chamber or cylinder 58 formed about the passage 30 or the longitudinal axis 28. The annular chamber 58 has a torus or donut shape and preferably has a circular cross section. Referring to FIG. 4, the housing 18 has first and second water openings 62 and 64, or left and right openings, formed therein which extend into the annular chamber 58. The first and second water openings 62 and 64 are located relatively close together with a small space in between them. The first and second water openings 62 and 64 allow water into, and/or out of, the annular chamber 58.

A plug or stop 68 is disposed in the annular chamber 58 between the first and second water openings 62 and 64, or at the small space between the first and second water openings. The water openings 62 and 64 are located relatively close to the plug 68, with one of the water openings 62 and 64 being located on one side of the plug 68. The plug 68 has the same cross section as the annular chamber 58, such as circular. In addition, the plug 68 has a perimeter or edge which seals against an inner wall of the annular chamber 58.

A reciprocating drive piston 74 is slidably disposed in the annular chamber 58. The drive piston 74 may move or slide within the annular chamber 58 in a rotational motion. The drive piston 74 has the same cross section as the annular chamber 58, such as circular. The drive piston 74 has a perimeter or edge which slidingly seals against the inner wall of the annular chamber 58.

The drive piston 74 is coupled to the pivoting cutter 54 such that as the drive piston 74 rotates in the annular chamber 58, it drives or forces the pivoting cutter 54 to pivot in the passage 30 of the housing 18. Referring to FIG. 3, an annular opening 78 is formed in an inner wall of the annular chamber 58 and a wall of the passage 30 so that the opening 78 extends between the passage 30 and annular chamber 58. The drive piston 74 and pivoting cutter 54 couple through the annular opening 78.

The drive piston 74 divides the annular chamber 58 into a first and second chambers 82 and 84, or left and right chambers. The first and second chambers 82 and 84 are arc-shaped, or partially annular. The first and second chambers 82 and 84 are defined by the walls of the annular chamber and the plug 68 on one end and the drive piston 74 on the other end. Thus, the first water opening 62 is formed in the first chamber 82 while the second water opening 64 is formed in the second chamber 84. The drive piston 74 has opposite sides, with one side in communication with the first chamber 82 and the other side in communication with the second chamber 84.

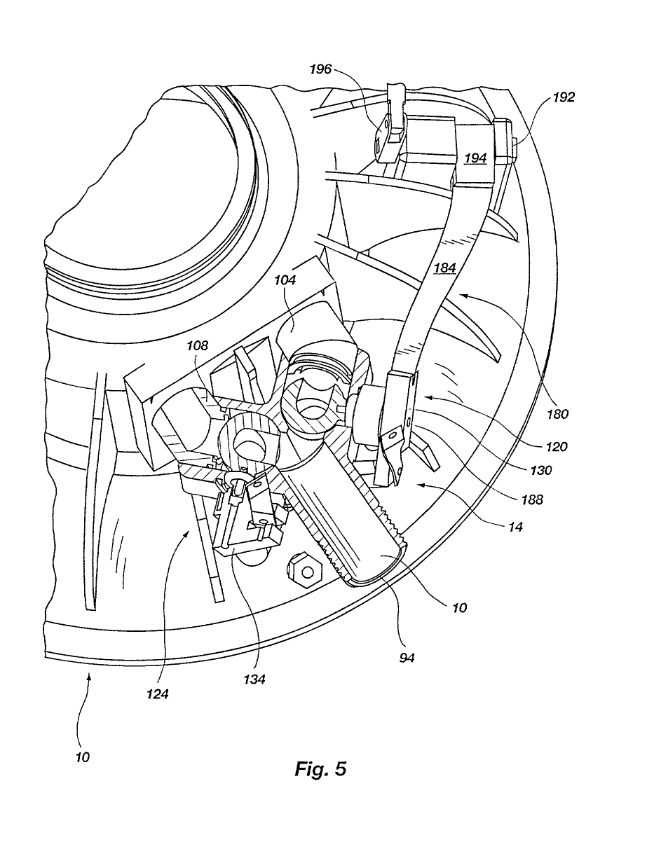

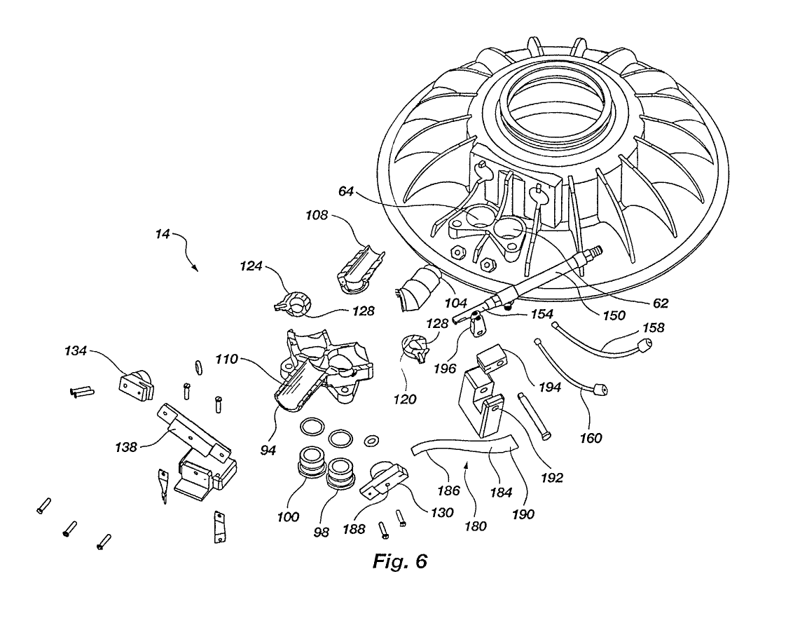

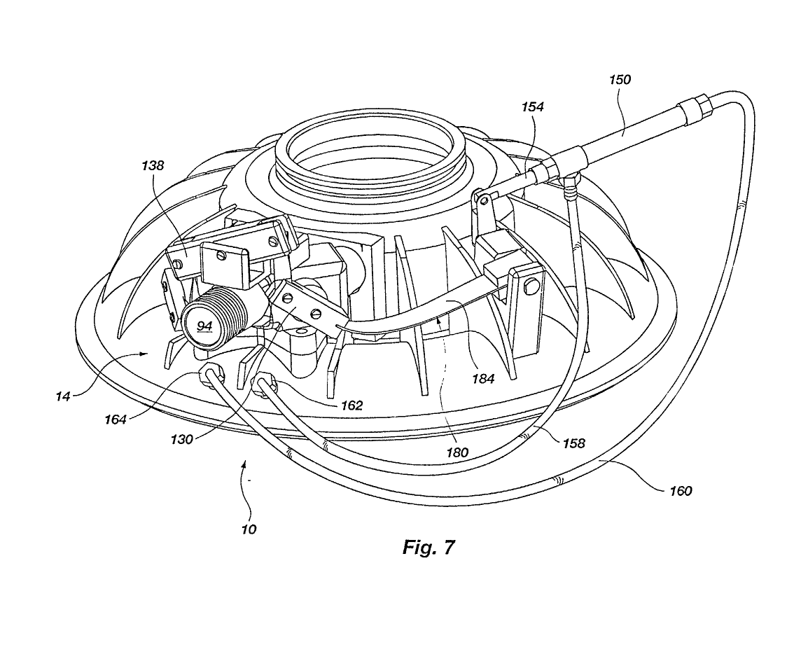

Referring to FIGS. 4-9, the back-pressure responsive, self-reversing, control valve 14 is advantageously coupled to the apparatus housing 18, or to the first and second water openings 62 and 64. The control valve 14 supplies pressurized water from a source of pressurized water alternatively to the first and second water openings 62 and 64, and thus to first and second chambers 82 and 84, to drive the drive piston 74 in a reciprocal manner.

The valve 14 may have a valve housing coupled to the apparatus housing 18, and a water inlet 94 for receiving pressurized water. The inlet 94 may be configured for being coupled to a pipe, and thus may have a female pipe thread formed therein. Alternatively, the inlet 94 may be configured for being coupled to tubing, and thus may have a male barb end.

The valve housing has first and second water openings 98 and 100 coupled to the first and second water openings 62 and 64 of the apparatus housing 18. The valve housing also has first and second exhaust openings or outlets 104 and 108 couple or direct water into the interior of the disposal apparatus 10. A fluid passageway 110 extends between the inlet 94 and the outlets 104 and 108, and may have a Y-shaped configuration, as shown.

The control valve 14 advantageously includes first and second bi-directional valves 120 and 124 which operate cooperatively with respect to one another. The valves 120 and 124 alternately direct fluid from the inlet 94 to the respective first and second openings 98 and 100, and thus the first and second openings 62 and 64, or first and second sides 82 and 84, of the waste disposal apparatus 10. In addition, the valves 120 and 124 also drain fluid from the respective first and second openings 98 and 100, and thus from the first and second openings 62 and 64, or first and second sides 82 and 84, of the waste disposal apparatus 10, to the outlets 104 and 108. One of the valves 120 and 124 simultaneously drains water while the other valve directs fluid to the other opening. Thus, the valves 120 and 124 alternately direct water to, and drain water from, opposite sides of the drive piston 74 of the waste disposal apparatus 10.

The valves 120 and 124 are disposed in the fluid passageway 110 between the inlet 94 and the outlets 104 and 108, and are operable to direct the fluid (i) from the inlet 94 to the respective first and second openings 98 and 100, and (ii) from the respective first and second openings 98 and 100 to the outlets 104 and 108. Preferably, the valves 120 and 124 are ball valves, each having a ball with an angular passage 128. The balls and angular passages 128 are pivotable between a first power orientation and a second drain orientation. In the first power orientation, the angular passage 128 directs fluid from the inlet 94 to the respective first or second opening 98 or 100. In the second drain orientation, the angular passage 128 directs fluid from the respective first or second opening 98 or 100 to the outlets 104 and 108.

Although the control valve 14 has been described as having a single inlet 94 and first and second outlets 140 and 142, it is of course understood that the valve 14 can have one or more inlets, and one or more outlets.

The first and second valves 120 and 124 preferably are is operatively interconnected to simultaneously alternate operation. First and second valve levers 130 and 134 are coupled to the respective first and second valves 120 and 124 to operate the valves and direct fluid flow. An armature 138 is coupled to and between the first and second valve levers 130 and 134 to operatively interconnect the first and second valves. The armature 138 may be pivotally coupled to the valve housing at an intermediate point, and may be coupled at its ends to the valve levers 130 and 134 by extensions, such that the armature 138 pivots back-and-forth as the valve levers 130 and 134 pivot. Thus, the valves 120 and 124 are interconnected, and pivot or operate together.

One advantage of the bi-directional valves 120 and 124 is the large fluid openings through the valves. Such large openings or inner diameters are less likely to become clogged by debris. In addition, such large openings improve the flow rate and reduce losses through the valve. The large openings also allow for higher flow rates, and thus higher speeds for the cutters. In addition, the larger openings provide increased dynamic pressure, and thus increased force during movement of the drive piston.

A back-pressure responsive actuator 150 is operatively coupled to the valves 120 and 124, which is responsive to back-pressure at the first and second openings 98 and 100, and thus the first and second sides 82 and 84 of the drive piston 74, to operate the valves 120 and 124. The actuator can be a dual action piston/cylinder, with a piston slidably disposed in a cylinder, and a rod 154 coupled to the piston to impart movement of the piston outside the cylinder. The actuator 150 can be operatively coupled to the first and second openings 98 and 100 by fluid lines 158 and 160 which communicate fluid flow and pressure from the annular chamber or cylinder 58 to the actuator 150. The first fluid line 158 is coupled to a first port 162 which is in fluid communication with the first opening 98 and first side 82 of the annular chamber 58. Similarly, the second fluid line 160 is coupled to a second port 164 which is in fluid communication with the second opening 100 and the second side 84 of the annular chamber 58. Thus, back-pressure at the first and second openings 98 and 100, or in the first and second chambers 82 and 84, is transmitted through the fluid lines 158 and 160 to opposite sides of the actuator 150. Thus, as pressure builds up in one side of the annular chamber, due to the drive piston 74 reaching its end of travel, or a clog in the cutters, the pressure acts on the actuator 150, which in turn acts on the valves 120 and 124 to operate or pivot the valves, and thus redirect the flow of fluid. The fluid lines preferably are narrow to provide additional resistance to the flow of fluid and transmittal of pressure to the actuator 150 in order to delay actuation of the actuator 150 to maintain pressure in the annular drive chamber before the drive piston switches directions.

A hysteretic mechanism 180 advantageously is coupled between the actuator 150 and the valves 120 and 124 to cause the actuator 150 to operate or switch the valves 120 and 124 rapidly between the first and second positions. The hysteretic mechanism 180 and actuator 150 form a hysteretic actuator which rapidly operates or switches the valves upon a predetermined amount of back-pressure at either the first or second openings. The hysteretic mechanism 180 provides force for operating or pivoting the valves in a snap-action. In addition, the hysteretic mechanism may resist operation of the valves until a certain back-pressure has been reached. Thus, the actuator 150 may begin actuating in response to back-pressure increasing in the annular drive chamber, but the hysteretic mechanism 180 may resist operation of the valves. Such a hysteretic mechanism may be designed for a specific operating pressure.

The hysteretic mechanism 180 can be a bi-stable mechanism having two stable positions, each corresponding to the first power position or the second drain position of the valves 120 and 124. Thus, the mechanism requires a certain amount of force to move from one stable position to the other.

The hysteretic mechanism 180 can include a resilient member or spring 184, such as an elongated flexible and resilient material which stores energy during bending. Thus, the resilient member 184 can be a strip of spring metal or the like. The resilient member 184 preferably is straight or linear in its natural position. The resilient member 184 has a first end 186 pivotally coupled to the valves, or first valve 120, at a first pivot point 188 (which can be a pivot point of the valve itself), and a second end 190 pivotally coupled to the pressure responsive actuator 150 at a second pivot point 192. The first end 186 can be attached to the first valve lever 130, and the second end 190 attached to a pivot block 194 which is pivotally secured with respect to the valve 14. A lever arm 196 can be pivotally coupled to the rod 154 of the actuator 150, and attached to the pivot block 194 such that the pivot block 194 and lever arm 196 pivot together as the actuator 150 exerts a force, or as the rod 154 extends.

The distance between the first and second pivot points 188 and 192 is fixed. Thus, as the actuator 150 actuates, or exerts a force, the rod 154 and lever arm 196 cause the pivot block 194, and thus the second end 190 of the resilient member 184 to pivot about the second pivot point 192. Because the distance between the pivot points 188 and 192 is fixed, the resilient member 192 is caused to deflect or bend. As the resilient member 192 continues to bend, the pivoting of the second end 192 exerts a force on the second end 188. The force developed in the resilient member 192 causes the first end 188 to pivot, thus operating or pivoting the valves with a snap-action.

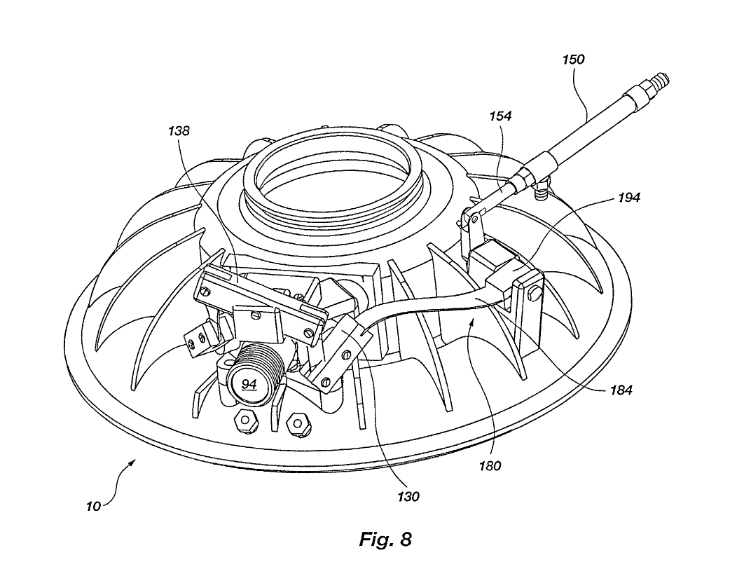

As the actuator 150 acts on the resilient member 180, the resilient member 180 deflects through various configurations. Initially, the resilient member 180 has a first arcuate configuration, as shown in FIG. 7, which corresponds with the first power position of the first valve 120, and the second drain position of the second valve 124. A second opposite arcuate configuration of the resilient member, opposite that shown in FIG. 7, corresponds with the second drain position of the first valve 120, and the first power position of the second valve 124. The resilient member 180 is at a stable position in the first and second arcuate configurations. An intermediate S-shaped configuration occurs between the first and second arcuate configurations, as shown in FIG. 8, in which the resilient member 180 stores energy used to switch the valves between the first and second positions. The resilient member 180 is unstable in the S-shape configuration. It will be appreciated that the resilient member 180 stores the energy applied by the actuator 150, and rapidly applies that energy to operating or pivoting the valves. The spring member 180 is one example of a hysteretic mechanism. It is of course understood that other types of hysteretic mechanisms can be used to create the snap-action.

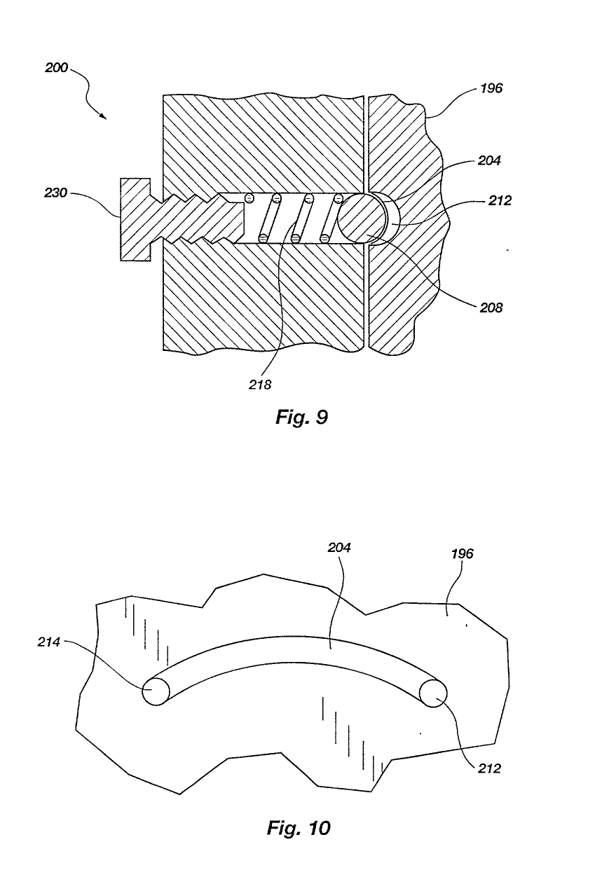

Referring to FIGS. 9 and 10, a detent mechanism 200 can be used to exert a resistance force to movement of the actuator 150. The detent mechanism 200 operatively engages the pressure response actuator 150, either directly, or indirectly, such as by engaging the lever arm 196, as shown. For example, a detent track 204 can be formed in the lever arm 196 to receive a detent ball 208. The detent track 204 can be arcuate to account for the pivoting movement of the lever arm 196. Indentations 212 and 214 can be formed in the track 204, such as at opposite ends, to receive the detent ball 208 which correspond to opposite ends of travel of the lever arm 196. The detent ball 208 is biased against the track 204 and indentations 212 and 214 by a spring 218, such that the detent ball 208 received within an indentation 212 or 214 resists pivotal movement of the lever arm 196, and thus the valves 120 and 124. The ball 208 can be moved out of the indentations 212 and 214 once the actuator 150 applies a sufficient force to the lever arm 196. Thus, the detent mechanism 200 requires a certain amount of back-pressure to develop in the drive chamber of the disposal apparatus before allowing the apparatus or valves to reverse direction. It is of course understood that different detent mechanisms can be used, and can engage different parts of the disposal unit, such as the rod of the piston/cylinder, etc.

In addition, an adjustment member 230 can adjust the amount of resistance applied by the detent mechanism 200, and thus vary the required back-pressure to suit the available pressure from the fluid or water source. For example, the adjustment member 230 can engage the spring 218 to vary the compression of the spring. The adjustment member 230 can have screw threads which allow the adjustment member 230 to be advanced or retracted by turning the adjustment member 230, and thus compress or relax the spring 218. Referring again to FIGS. 1-10, in operation, water enters the control valve 14 through the inlet 94, and directed to one side of drive piston 74 to drive the drive piston in the drive chamber 58, and thus drive the pivoting cutters 80 and 54. For example, the first bi-directional valve 120 may direct water to the first side 82 of the drive chamber 58 through the first opening 194 of the control valve 14, and first opening 98 of the drive chamber 58. In addition, the control valve 14 simultaneously drains, or facilitates drainage, of water out of the other side of the drive chamber. For example, the second bi-directional valve 124 may drain water from the second side 84 of the drive chamber 58 through the second opening 108 of the control valve 14, and the second opening 100 of the drive chamber 58.

As the drive piston 74 reaches the end of its travel, or as the cutters become clogged, the drive piston 74 ceases to move or pivot, and water pressure in the drive chamber 58 increases. For example, water pressure in the first side 82 of the drive chamber 58 increases. In addition, water flows through the fluid lines 158 and 160 to and from the actuator 150, or piston/cylinder. For example, the water flows through the first fluid line 158 from the first port 162 of the first side 82 of the drive chamber 58 to one side of the actuator 150, or piston/cylinder. As the water pressure in the first side 82 of the drive chamber 58 increases, the water pressure in the actuator 150, or piston/cylinder, causes the rod 154 to displace, or exert a force. For example, the rod 154 may be withdrawn into the actuator 150, or piston/cylinder.

The actuator 150 operates the bi-directional valves 120 and 124 in response to the back-pressure in the drive chamber 58. In addition, the hysteretic mechanism 180 resists operation of the valves by the actuator 150 until sufficient force exists to rapidly operate the valves 120 and 124, and until sufficient driving force has been reached in the drive chamber 58.

As the rod 154 displaces, it causes the lever arm 196, and thus the pivot block 194, to pivot. In addition, the displacement of the rod 154 causes the second end 190 of the resilient member 184 to pivot. As the second end 190 of the resilient member 184 pivots, the resilient member 184 bends, storing energy. Finally, the resilient member 184 reaches a maximum deformation point or energy level, and resilient member 184 rapidly snaps from the bent configuration, or higher energy state, to an arcuate configuration, or lower energy state. As the resilient member 184 snaps into the arcuate configuration, the first end 186 of the resilient member 184 is caused to move, thus pivoting the first valve lever 130.

Pivoting the first valve lever 130 causes the pivot arm 138 to pivot, and thus pivot the second valve lever 134. Of course, pivoting the valve levers 130 and 134 causes the first and second bi-directional valves 120 and 124 to pivot. For example, the first valve 120 is caused to pivot so as to drain water from the first side 82 of the drive chamber 58, through the first opening 104 in the valve 14, and first opening 98 in the drive chamber 58. In addition, the second valve 124 now directs water to the second side 84 of the drive chamber 58, from the inlet 94 and through the second opening 108 in the valve 14, and second opening 100 in the drive chamber 58. Thus, the direction of the drive piston 74 is reversed.

Although the above described control valve has been described as include a pair of bi-directional valves, it is of course understood that four uni-directional valves can be used in place of the pair of bi-directional valves.

It is to be understood that the above-described arrangements are only illustrative of the application of the principles of the present invention. Numerous modifications and alternative arrangements may be devised by those skilled in the art without departing from the spirit and scope of the present invention and the appended claims are intended to cover such modifications and arrangements. Thus, while the present invention has been shown in the drawings and fully described above with particularity and detail in connection with what is presently deemed to be the most practical and preferred embodiment(s) of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims.

What is claimed is:

1. A back-pressure responsive, self-reversing, control valve, comprising:
a) first and second valves, each configured to operate cooperatively with respect to one another to:
(i) direct fluid from an inlet to a respective first and second opening, and
(ii) facilitate drainage of fluid from one of the respective first and second openings to an outlet, one of the first and second valves facilitating drainage of fluid from one of the respective first and second openings to an outlet while the other one of the first and second valves directs fluid to the other one of the respective first and second openings; and
b) a back-pressure responsive actuator, operatively coupled to the first and second valves, to operate the first and second valves cooperatively in response to back-pressure at the first and second openings.

2. A control valve in accordance with claim 1, wherein the first and second valves include:
first and second ball valves, each having a ball with an angular passage pivotable between:
(i) a first power orientation in which the angular passage directs fluid from the inlet to the respective first and second openings, and
(ii) a second drain orientation in which the angular passage directs fluid from the respective first and second opening to the outlet.

3. A control valve in accordance with claim 1, further including a fluid passageway extending between the inlet and the outlet; wherein the first and second valves are disposed in the fluid passageway between the inlet and the outlet; and wherein the valves are operable to direct the fluid (i) from the inlet to the respective first and second openings, and (ii) from the respective first and second openings to the outlet.

4. A control valve in accordance with claim 1, wherein the first and second valves are operatively interconnected to simultaneously alternate operation.

5. A control valve in accordance with claim 1, further comprising:
a) first and second valve levers, coupled to the respective first and second valves, to operate the valves and direct fluid flow; and
b) an armature, coupled to and between the first and second valve levers, to operatively interconnect the first and second valves.

6. A control valve in accordance with claim 1, further comprising:
a water powered waste disposal unit driven by pressurized water and having a reciprocating drive piston slidably disposed in a drive chamber and coupled to cutters in the unit for cutting waste, the drive chamber having first and second openings formed therein on opposite sides of the drive piston coupled to the first and second openings of the valves.

7. A water powered waste disposal apparatus driven by pressurized water, comprising:
a) a reciprocating drive piston slidably disposed in a drive chamber having first and second openings formed therein on opposite sides of the drive piston;
b) cutters, coupled to the drive piston, configured to cut waste;
c) first and second valves, each configured to operate cooperatively with respect to one another to:
(i) direct fluid from an inlet to the respective first and second openings of the drive chamber and opposite sides of the drive piston, and
(ii) facilitate drainage of fluid from the respective first and second openings of the drive chamber to an outlet, one of the first and second valves facilitating drainage from one of the respective first and second openings, while the other one of the first and second valves directs fluid to the other one of the respective first and second openings; and
d) a back-pressure responsive actuator, operatively coupled to the first and second valves, to operate the first and second valves cooperatively in response to back-pressure at the first and second openings.

8. An apparatus in accordance with claim 7, wherein the first and second valves include:
first and second ball valves, each having a ball with an angular passage pivotable between:
(i) a first power orientation in which the angular passage directs fluid from the inlet to the respective first and second openings, and
(ii) a second drain orientation in which the angular passage directs fluid from the respective first and second opening to the outlet.

9. An apparatus in accordance with claim 7, further including a fluid passageway extending between the inlet and the outlet; wherein the first and second valves are disposed in the fluid passageway between the inlet and the outlet; and wherein the valves are operable to direct the fluid (i) from the inlet to the respective first and second openings, and (ii) from the respective first and second openings to the outlet.

10. An apparatus in accordance with claim 7, wherein the first and second valves are operatively interconnected to simultaneously alternate operation.

11. An apparatus in accordance with claim 7, further comprising:
a) first and second valve levers, coupled to the respective first and second valves, to operate the valves and direct fluid flow; and
b) an armature, coupled to and between the first and second valve levers, to operatively interconnect the first and second valves.

12. A back-pressure responsive, self-reversing, control valve, comprising:
a) first and second valves, each cooperatively operable between:
(i) a first power position in which the first and second valves direct fluid from an inlet to respective first and second openings, and
(ii) a second drain position in which the first and second valves facilitate drainage from the respective first and second openings to an outlet, one of the first and second valves facilitating drainage from one of the respective first and second openings, while the other one of the first and second valves directs fluid to the other one of the respective first and second openings; and
b) a hysteretic actuator, operatively coupled to the first and second valves, responsive to back pressure at the first and second openings to operate the first and second valves rapidly between the first and second positions upon a predetermined amount of back-pressure at either the first or second opening.

13. A control valve in accordance with claim 12, wherein the hyesteretic actuator includes:
a bi-stable mechanism having two stable positions each corresponding to one the first power position or second drain position of the valves.

14. A control valve in accordance with claim 12, wherein the hysteretic actuator includes:
a) a pressure response actuator, operatively coupled to the first and second openings, configured to exert a force in response to back-pressure at the first and second openings; and
b) a spring member, coupled to and between the valves and the pressure responsive actuator.

15. A control valve in accordance with claim 14, wherein the resilient member moves between:
(i) a first arcuate configuration corresponding with the first power position,
(ii) a second opposite arcuate configuration corresponding with the second drain position, and
(iii) an s-shaped configuration between the first and second arcuate configurations in which the resilient member stores energy used to switch the valves between the first and second positions.

16. A control valve in accordance with claim 14, further comprising:
a) a detent mechanism, operatively engaging the pressure response actuator, to exert a resistance force to movement of the actuator; and
b) an adjustment member, coupled to the detent mechanism, to adjust the amount of resistance applied by the detent.

17. A control valve in accordance with claim 12, wherein the hysteretic actuator includes:
a cylinder with a piston movable disposed therein, each side of the cylinder being fluidly coupled to one of the first and second openings.

18. A control valve in accordance with claim 12, further comprising:
a water powered waste disposal unit driven by pressurized water and having a reciprocating drive piston slidably disposed in a drive chamber and coupled to cutters in the unit for cutting waste, the drive chamber having first and second openings formed therein on opposite sides of the drive piston coupled to the first and second openings of the valves.

19. A water powered waste disposal apparatus driven by pressurized water, comprising:
a) a reciprocating drive piston slidably disposed in a drive chamber having first and second openings formed therein on opposite sides of the drive piston;
b) cutters, coupled to the drive piston, configured to cut waste;
c) first and second valves, each alternately operable between:
(i) a first power position in which the first and second valves direct fluid from an inlet to the respective first and second openings of the drive chamber and opposite sides of the drive piston, and
(ii) a second drain position in which the first and second valves facilitate drainage from the respective first and second openings of the drive chamber to an outlet, one of the first and second valves facilitating drainage from one of the respective first and second openings, while the other one of the first and second valves directs fluid to the other one of the respective first and second openings; and
d) a hysteretic actuator, operatively coupled to the first and second valves, responsive to back pressure at the first and second openings to operate the first and second valves rapidly between the first and second positions upon a predetermined amount of back-pressure at either the first or second opening.

20. An apparatus in accordance with claim 19, wherein the hyesteretic actuator includes:
a bi-stable mechanism having two stable positions each corresponding to one the first power position or second drain position of the valves.

21. An apparatus in accordance with claim 19, wherein the hysteretic actuator includes:
a) a pressure response actuator, operatively coupled to the first and second openings, configured to exert a force in response to back-pressure at the first and second openings; and
b) a spring member, coupled to and between the valves and the pressure responsive actuator.

22. An apparatus in accordance with claim 21, wherein the resilient member moves between:
(i) a first arcuate configuration corresponding with the first power position,
(ii) a second opposite arcuate configuration corresponding with the second drain position, and
(iii) an s-shaped configuration between the first and second arcuate configurations in which the resilient member stores energy used to switch the valves between the first and second positions.

23. An apparatus in accordance with claim 21, further comprising:
a) a detent mechanism, operatively engaging the pressure response actuator, to exert a resistance force to movement of the actuator; and
b) an adjustment member, coupled to the detent mechanism, to adjust the amount of resistance applied by the detent.

24. An apparatus in accordance with claim 19 wherein the hysteretic actuator includes:
a cylinder with a piston movable disposed therein, each side of the cylinder being fluidly coupled to one of the first and second openings.

25. A back-pressure responsive, self-reversing, control valve, comprising:
a) first and second valves operatively interconnected to simultaneously alternate between:
(i) a first power position in which the first and second valves direct fluid from an inlet to respective first and second openings, and
(ii) a second drain position in which the first and second valves facilitate drainage from the respective first and second openings to an outlet, one of the first and second valves facilitating drainage from one of the respective first and second openings, while the other one of the first and second valves directs fluid to the other one of the respective first and second openings;
b) a pressure responsive actuator, operatively coupled to the first and second openings, configured to exert a force in response to back-pressure at the first and second openings; and
c) a hysteretic mechanism, operatively coupled between the pressure responsive actuator and the first and second valves, to operate the first and second valves rapidly between the first and second positions.

26. A control valve in accordance with claim 25, wherein the wherein the first and second valves include:
first and second ball valves, each having a ball with an angular passage pivotable between:
(i) a first power orientation in which the angular passage directs fluid from the inlet to the respective first and second openings, and
(ii) a second drain orientation in which the angular passage directs fluid from the respective first and second opening to the outlet.

27. A control valve in accordance with claim 25, further including a fluid passageway extending between the inlet and the outlet; wherein the first and second valves are disposed in the fluid passageway between the inlet and the outlet; and wherein the valves are operable to direct the fluid (i) from the inlet to the respective first and second openings, and (ii) from the respective first and second openings to the outlet.

28. A control valve in accordance with claim 25, wherein the hyesteretic actuator includes:
a bi-stable mechanism having two stable positions each corresponding to one the first power position or second drain position of the valves.

29. A control valve in accordance with claim 25, wherein the hysteretic actuator includes:
a spring member having a first end pivotally coupled to the valves at a first pivot point, and a second end pivotally coupled to the pressure responsive actuator at a second pivot point.

30. A control valve in accordance with claim 29, wherein the resilient member moves between:
(i) a first arcuate configuration corresponding with the first power position,
(ii) a second opposite arcuate configuration corresponding with the second drain position, and
(iii) an s-shaped configuration between the first and second arcuate configurations in which the resilient member stores energy used to switch the valves between the first and second positions.

31. A control valve in accordance with claim 25, further comprising:
a) a detent mechanism, operatively engaging the pressure response actuator, to exert a resistance force to movement of the actuator; and
b) an adjustment member, coupled to the detent mechanism, to adjust the amount of resistance applied by the detent.

32. A control valve in accordance with claim 25, wherein the pressure responsive actuator includes:
a cylinder with a piston movable disposed therein, each side of the cylinder being fluidly coupled to the first and second openings.

33. A control valve in accordance with claim 25, further comprising:
a water powered waste disposal unit driven by pressurized water and having a reciprocating drive piston slidably disposed in a drive chamber and coupled to cutters in the unit for cutting waste, the drive chamber having first and second openings formed therein on opposite sides of the drive piston coupled to the first and second openings of the valves.

34. A water powered waste disposal apparatus driven by pressurized water, comprising:
a) a reciprocating drive piston slidably disposed in a drive chamber having first and second openings formed therein on opposite sides of the drive piston;
b) cutters, coupled to the drive piston, configured to cut waste;
c) first and second valves operatively interconnected to simultaneously alternate between:
(i) a first power position in which the first and second valves direct fluid from an inlet to the respective first and second openings of the drive chamber, and
(ii) a second drain position in which the first and second valves facilitate drainage from the respective first and second openings of the drive chamber to an outlet, one of the first and second valves facilitating drainage from one of the respective first and second openings, while the other one of the first and second valves directs fluid to the other one of the respective first and second openings;
d) first and second valve levers, coupled to the respective first and second valves, to operate the valves;
e) an armature, coupled to and between the first and second valve levers, to operatively interconnect the first and second valves;
f) a pressure responsive actuator, operatively coupled to the first and second openings of the drive chamber, configured to exert a force in response to back-pressure at the first and second openings; and
g) a hysteretic mechanism, operatively coupled between the pressure responsive actuator and the first and second valves, to operate the first and second valves rapidly between the first and second positions.
